(19) United States
(12) Patent Application Publication
(10) Pub. No.: US 2006/0119456 A1
(43) Pub. Date: Jun. 8, 2006

(54) Electric leakage protection socket

(76) Inventor: Ke Yuan, Yueqing City (CN)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 11/047,145

(22) Filed: Jan. 31, 2005

(30) Foreign Application Priority Data
Dec. 6, 2004 (CN) 200410066113.8

(51) Int. Cl. H01H 73/00

(52) U.S. Cl. 335/18

(57) ABSTRACT

This invention relates to an electric leakage protection socket, comprising a case in which a pin, a stationary contact chip, a movable contact chip, a magnetic ring, a circuit board, a trip coil, an iron core, a trip mechanism and a reset mechanism are installed; the reset spring is socketed outside the reset rod and the later forms a locating ring at its lower part; the trip mechanism comprises a sliding block, a self-locking plate and a spring, protruding shoulders are arranged on two sidewalls of the sliding block, a contact end of the movable contact chip is pressed against the protruding shoulder, a hole is axially machined on the sliding block, the lower part of the reset rod is inserted in the hole, the self-locking plate is in a shape of ‘7’ whose long edge passes through the transverse hole on the sliding block and has a locking hole matching to the locating ring, and one side of its short edge is pressed against the spring and another side adapts to the iron core. This invention overcome such shortcomings of existing technology as low safety, reliability and sensitivity and increase the sensitivity of the tripping of the electric leakage protection socket so that the equipment can be powered on only if it is started again after recovery of the electricity, with such advantages as simple structure, and convenient, safe and reliable operation.

### TECHNICAL FIELD

The present invention relates to an electric leakage protection socket.

### TECHNICAL BACKGROUND

The conventional electric leakage protection socket has generally two disadvantages, one of which is that no matter how good its protection function is, it will be still powered on in case of power interruption of the circuit during its use and supply power to the electric consumers directly when the power comes back again; such case is not in favor of the protection of electric consumer and human safety; another one of which is low sensitivity and poor reliability of the trip mechanism in the conventional electric leakage protection socket.

### SUMMARY OF THE INVENTION

The present invention provides an electric leakage protection socket that has simple structure, high sensitivity and safe and reliable use in order to overcome such problems as low safety, reliability and sensitivity technically of existing general electric leakage protection socket.

The technical scheme solving existing technical problems used in this invention is: comprising a case in which a pin, a stationary contact chip, a movable contact chip, a magnetic ring, a circuit board, a trip coil, a iron core, a trip mechanism and a reset mechanism are installed; the pin is connected to the stationary contact chip, one end of the movable contact chip is connected to the magnetic ring that is connected to the trip coil via the circuit board, and the trip coil drives the iron core to activate the trip mechanism, the reset mechanism is composed of a reset button, a reset rod and a reset spring, the reset spring is socketed outside the reset rod and the later forms a locating ring at its lower part; the trip mechanism comprises a sliding block, a self-locking plate and a spring, protruding shoulders are arranged on two sidewalls of the sliding block, a contact end of the movable contact chip is pressed against the protruding shoulder, a hole is axially machined on the sliding block, the lower part of the reset rod is inserted in the hole, the self-locking plate is in a shape of ‘7’ whose long edge passes through the transverse hole on the sliding block and has a locking hole matching to the locating ring, and one side of its short edge is pressed against the spring and another side adapts to the iron core.

This invention has also a testing mechanism, comprising a testing button, a testing plate and a resistor, the testing plate is connected to the pin, and the resistor contacting and matching to the testing plate is connected to the magnetic ring.

The movable contact chip is separated into two parts by an isolating groove transversely, and a silver-point contact is arranged on each of its contact end.

With the foregoing detailed design, this invention improves significantly the sensitivity of the trip of the electric leakage protection socket, and the equipment can be powered on only if the equipment is started again after recovery of the electricity, and has simple structure, and convenient, safe and reliable operation.

### DESCRIPTION OF ATTACHED FIGURES

The present invention will be described in details with reference to the attached figures and embodiments.

FIG. 1 is a structure sketch view of this invention;

FIG. 2 is a A-A section view of FIG. 1.

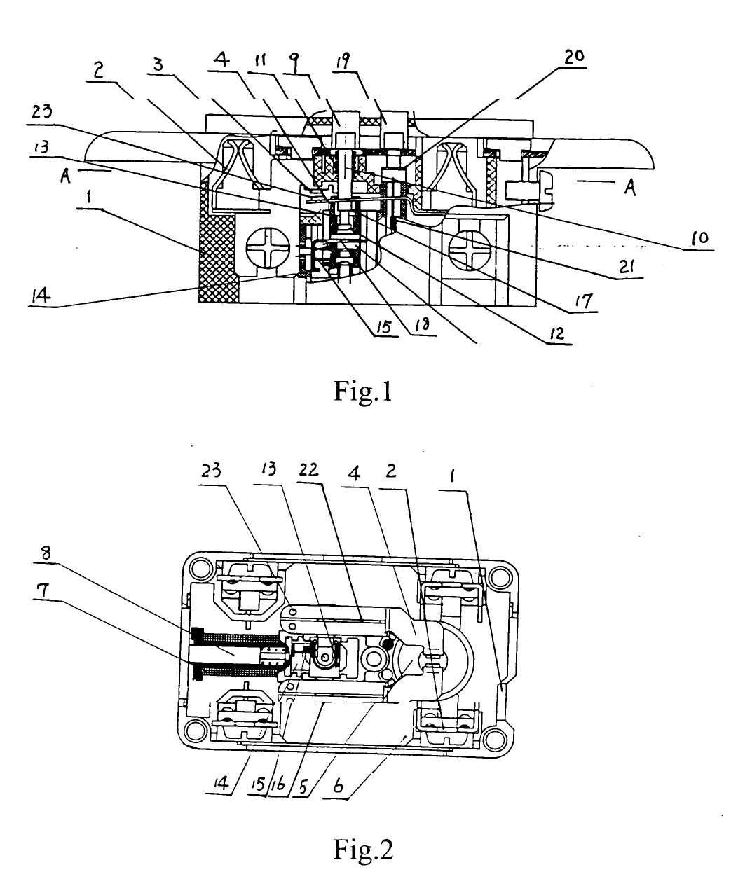

### DESCRIPTION OF THE PREFERRED EMBODIMENTS

Shown in the figures, this invention comprises a case 1 in which a pin 2, a stationary contact chip 3, a movable contact chip 4, a magnetic ring 5, a circuit board 6, a trip coil 7, a iron core 8, a trip mechanism and a reset mechanism are installed; the pin 2 is connected to the stationary contact chip 3, the movable contact chip 4 is separated into two parts by an isolating groove 22 transversely, and a silver-point contact 23 is arranged on each of its contact ends, this double silver point is in a closure design resulting in the increase of contact area, the decrease of contact resistance and the improvement of carrying capacity so as to enable to bear large transient current impulse, another end of the movable contact chip 4 is connected to the magnetic ring 5 that is connected to the trip coil 7 via the circuit board 6, the trip coil 7 drives the iron core 8 to activate the trip mechanism, the reset mechanism is composed of a reset button 9, a reset rod 10 and a reset spring 11, the reset spring 11 is socketed outside the reset rod 10 and the later 10 forms a locating ring 12 at its lower part; the trip mechanism comprises a sliding block 13, a self-locking plate 14 and a spring 15, protruding shoulders 16 are arranged on two sidewalls of the sliding block 13, a contact end of the movable contact chip 4 is pressed against the protruding shoulder 16, a hole 17 is axially machined on the sliding block 13, the lower part of the reset rod 10 is inserted in the hole 17, the self-locking plate 14 is in a shape of ‘7’ whose long edge passes through the transverse hole 24 on the sliding block 13 and has a locking hole 18 matching to the locating ring 12, and one side of its short edge is pressed against the spring 15 and another side adapts to the iron core 8. This invention additionally has a testing mechanism comprising a testing button 19, a testing plate 20 and a resistor 21, the testing plate 20 is connected to the pin 2, and the resistor 21 contacting and matching to the testing plate 20 is connected to the magnetic ring 5. In case of ground leakage current more than 6 milliampere, an electric leakage signal detected by the magnetic ring 5 will be amplified via the circuit board 6 and activate the silicon controlled rectifier to make the trip coil 7 produce a magnetic field so as to push the iron core 8; the sliding block 13 is to push the movable contact 4 to close the movable and stationary contacts 4 and 3, the iron core 8 pushes the self-locking plate 14 to make the sliding block 13 break away the upward tension of the reset spring 11 in order to make the movable contact 4 separate from the stationary contact 3 for the purpose of leakage trip protection. During the resetting, if the ground line is grounded and has the resistance smaller than 2 ohm, an electric leakage signal detected by the magnetic ring 5 will be amplified via the circuit board 6 and activate the silicon controlled rectifier to make the trip coil 7 produce a magnetic field which can drive the trip mechanism to trip. The reset button 9 and the testing button 19 share a 15K resistor 21, an electric leakage circuit and a trip mechanism, resulting in a simple circuit and less raw materials, the reset button 9 and the testing button 19 will detect the circuits once respectively while pressed so that the safety and reliability of the products are increased. The reset cannot be activated if no power is in the circuit board 6 and the trip coil 7 due to inverse connection of input and output.

1. An electric leakage protection socket, comprising a case in which a pin, a stationary contact chip, a movable contact chip, a magnetic ring, a circuit board, a trip coil, a iron core, a trip mechanism and a reset mechanism are installed; the pin is connected to the stationary contact chip, one end of the movable contact chip is connected to the magnetic ring that is connected to the trip coil via the circuit board, and the trip coil drives the iron core to activate the trip mechanism, wherein the reset mechanism is composed of a reset button (9), a reset rod (10) and a reset spring (11), the reset spring (11) is socketed outside the reset rod (10) and the later forms a locating ring (12) at its lower part; the trip mechanism comprises a sliding block (13), a self-locking plate (14) and a spring (15), protruding shoulders (16) are arranged on two sidewalls of the sliding block (13), a contact end of the movable contact chip (4) is pressed against the protruding shoulder (16), a hole (17) is axially machined on the sliding block (13), the lower part of the reset rod (10) is inserted in the hole (17), the self-locking plate (14) is in a shape of ‘7’ whose long edge passes through the transverse hole (24) on the sliding block (13) and has a locking hole (18) matching to the locating ring (12), and one side of its short edge is pressed against the spring (15) and another side adapts to the iron core (8).

2. An electric leakage protection socket according to claim 1, wherein a testing mechanism is also provided, comprising a testing button (19), a testing plate (20) and a resistor (21), the testing plate (20) is connected to the pin (2), and the resistor (21) contacting and matching to the testing plate is connected to the magnetic ring (5).

3. An electric leakage protection socket according to claim 1, wherein the movable contact chip (4) is separated into two parts by an isolating groove (22) transversely, and a silver-point contact (23) is arranged on each of its contact ends.

4. An electric leakage protection socket according to claim 2, wherein the movable contact chip (4) is separated into two parts by an isolating groove (22) transversely, and a silver-point contact (23) is arranged on each of its contact ends.
